(19) United States
(12) Patent Application Publication
(10) Pub. No.: US 2025/0042526 A1
(43) Pub. Date: Feb. 6, 2025

(54) WATERCRAFT PROPULSION SYSTEM, AND WATERCRAFT

(71) Applicant: YAMAHA HATSUDOKI KABUSHIKI KAISHA, Iwata-Shi (JP)

(72) Inventor: Yuji IKEGAYA, Shizuoka (JP)

(21) Appl. No.: 18/738,359

(22) Filed: Jun. 10, 2024

(30) Foreign Application Priority Data
Jul. 31, 2023 (JP) 2023-124900

(51) Int. Cl. B63H 21/20; B63H 21/14; B63H 21/17; B63H 21/21

(52) U.S. Cl. CPC B63H 21/20; B63H 21/14; B63H 21/17; B63H 21/21; B63H 2021/205; B63H 2021/216

(57) ABSTRACT

A watercraft propulsion system includes an engine propulsion device including a power generator, an electric propulsion device connected to a battery charged by the power generator, and a controller. The controller includes an extender mode in which the electric propulsion device generates a propulsive force and the power generator of the engine propulsion device is driven to charge the battery. The controller is configured or programmed to change an engine speed of the engine propulsion device according to a watercraft speed in the extender mode.

### CROSS REFERENCE TO RELATED APPLICATIONS

This application claims the benefit of priority to Japanese Patent Application No. 2023-124900 filed on Jul. 31, 2023. The entire contents of this application are hereby incorporated herein by reference.

### BACKGROUND OF THE INVENTION

### 1. Field of the Invention

The present invention relates to watercraft propulsion systems, and watercraft including the watercraft propulsion systems.

### 2. Description of the Related Art

US 2018/0134354 A1 discloses a watercraft propulsion system which includes an engine propulsion device including an engine as its power source, and an electric propulsion device including an electric motor as its power source. In an electric mode in which only the propulsive force of the electric propulsion device is utilized, the driving of the engine is also permitted. In this case, the engine propulsion device generates no propulsive force, but the engine drives a power generator to charge a battery.

### SUMMARY OF THE INVENTION

The inventor of example embodiments of the present invention described and claimed in the present application conducted an extensive study and research regarding a watercraft propulsion system, such as the one described above, and in doing so, discovered and first recognized new unique challenges and previously unrecognized possibilities for improvements as described in greater detail below.

The battery, which supplies electric power to the electric motor, is charged by the power generator of the engine propulsion device thus making it possible to extend a travel range for which a watercraft is powered by the electric propulsion device. That is, this operation mode is a so-called extender mode (range extender mode). In US 2018/0134354 A1, there is no specific description of the behavior of the engine propulsion device in the extender mode.

In view of the foregoing, example embodiments of the present invention provide watercraft propulsion systems that are able to properly control an engine in an extender mode, and watercraft including the watercraft propulsion systems.

In order to overcome the previously unrecognized and unsolved challenges described above, an example embodiment of the present invention provides a watercraft propulsion system including an engine propulsion device including a power generator, an electric propulsion device connected to a battery charged by the power generator, and a controller. The controller includes at least one operation mode including an extender mode in which the electric propulsion device generates a propulsive force and the power generator of the engine propulsion device is driven to charge the battery, and the controller is configured or programmed to change an engine speed of the engine propulsion device according to a watercraft speed in the extender mode.

The electric propulsion device is convenient when a watercraft is to quietly sail at a lower speed. The extender mode in which the battery is charged by the power generator of the engine propulsion device to supply electric power to the electric propulsion device extends a travel range for which the watercraft is powered by the electric propulsion device. If the engine sound of the engine propulsion device is loud, however, the quietness of the watercraft is deteriorated. In this aspect, it is preferred to keep the engine speed at a lower level. When the watercraft speed is high, on the other hand, water sound and wind sound generated by the hull of the watercraft are loud. Therefore, the product value of the watercraft is not significantly influenced by the generation of a relatively loud engine sound. In addition, the electric propulsion device is liable to have an increased power consumption when the watercraft speed is high. Therefore, the power generator preferably has a greater battery charging amount.

In this example embodiment, therefore, the engine speed of the engine propulsion device is changed according to the watercraft speed. This makes it possible to properly charge the battery by the power generator of the engine propulsion device without significantly influencing the product value of the watercraft.

In an example embodiment of the present invention, the controller is configured or programmed to keep the engine speed of the engine propulsion device at a predetermined target power generation engine speed level when the watercraft speed is not higher than a predetermined watercraft speed threshold in the extender mode. Further, the controller is configured or programmed to keep the engine speed higher than the target power generation engine speed level when the watercraft speed is higher than the predetermined watercraft speed threshold in the extender mode.

With this arrangement, the engine speed of the engine propulsion device is keep at the predetermined target power generation engine speed level when the watercraft speed is not higher than the predetermined watercraft speed threshold. Therefore, the battery is reliably charged. When the watercraft speed is increased to higher than the predetermined watercraft speed threshold, the battery charging amount is increased by increasing the engine speed to higher than the target power generation engine speed level.

In an example embodiment of the present invention, the watercraft propulsion system further includes a target power generation engine speed level setter operable by a user to variably set the target power generation engine speed level.

With this arrangement, the user can increase or reduce the target power generation engine speed level as required and, therefore, set the target power generation engine speed level so as to place more importance, for example, on the quietness of the watercraft or on the charging of the battery.

The target power generation engine speed level setter may be configured to directly set a target engine speed level, or may be configured to set a target engine speed level indirectly by setting a power generation level.

In an example embodiment of the present invention, the engine propulsion device includes an engine, a propeller, and a shift mechanism to interrupt a power transmission path between the engine and the propeller. The engine propulsion device is configured to allow the shift mechanism to shift in at an engine speed of not higher than a predetermined target shift-in engine speed level. The target power generation engine speed level is not higher than the target shift-in engine speed level.

With this arrangement, the target power generation engine speed level to be used when the watercraft speed is not higher than the predetermined watercraft speed threshold is not higher than the target shift-in engine speed level. Therefore, the shift-in is allowed at any time as required without adjusting the engine speed when the watercraft speed is not higher than the predetermined watercraft speed threshold. If the target power generation engine speed level is higher than the target shift-in engine speed level, a deceleration control must first be performed to reduce the engine speed to the target shift-in engine speed level and then the shift mechanism is allowed to shift in when a shift-in request is issued during sailing of the watercraft at a watercraft speed of not higher than the predetermined watercraft speed threshold. Therefore, the shift-in is often delayed.

Where the target power generation engine speed level is variably set by the target power generation engine speed level setter, the target power generation engine speed level setter is preferably configured to set the target power generation engine speed level at not higher than the target shift-in engine speed level.

In an example embodiment of the present invention, the engine propulsion device includes an engine, a propeller, and a shift mechanism to interrupt a power transmission path between the engine and the propeller. The engine propulsion device is configured to allow the shift mechanism to shift in at an engine speed of not higher than a predetermined target shift-in engine speed level. The controller is configured or programmed to perform a deceleration control to reduce the engine speed of the engine propulsion device to not higher than the target shift-in engine speed level when a shift-in request is received in the extender mode.

With this arrangement, the deceleration control is performed to reduce the engine speed to not higher than the target shift-in engine speed level in response to the shift-in request when the target power generation engine speed level is higher than the target shift-in engine speed level. This makes it possible to allow the shift mechanism to shift in at an engine speed of not higher than the target shift-in engine speed level thus reducing a shock (shift shock) and sound which may otherwise occur due to the shift-in.

In an example embodiment of the present invention, the watercraft speed is a watercraft log speed. With this arrangement, the engine speed can be changed according to the watercraft log speed in the extender mode. Therefore, the engine speed can be changed according to the water sound.

In an example embodiment of the present invention, the watercraft speed is a watercraft ground speed. With this arrangement, the engine speed can be changed according to the watercraft ground speed in the extender mode. Therefore, the engine speed can be changed according to the wind sound.

In an example embodiment of the present invention, the engine propulsion device is an outboard motor.

Another example embodiment of the present invention provides a watercraft propulsion system including an electric propulsion device connected to a battery charged by a power generator driven by an engine, and a controller configured or programmed to change a speed of the engine according to a watercraft speed.

With this arrangement, the engine speed is changed according to the watercraft speed and, therefore, the engine speed is increased or reduced according to the water sound and the wind sound generated by the hull of the watercraft. This makes it possible to cause the electric propulsion device to generate a propulsive force while properly charging the battery.

In an example embodiment of the present invention, the watercraft propulsion system includes an outboard motor including the engine.

Another further example embodiment of the present invention provides a watercraft including a hull, and a watercraft propulsion system mounted on the hull and including any of the aforementioned features.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a plan view showing an exemplary construction of a watercraft mounted with a watercraft propulsion system according to an example embodiment of the present invention.

FIG. 2 is a port side view of the watercraft as seen from a left side with respect to a bow direction of the watercraft.

FIG. 3 is a side view showing the structure of an engine outboard motor by way of an example.

FIG. 4 is a side view showing the structure of an electric outboard motor by way of an example.

FIG. 5 is a rear view of the electric outboard motor as seen from a rear side of the watercraft.

FIG. 6 is a block diagram showing the configuration of the watercraft propulsion system by way of an example.

FIG. 7 is a perspective view showing the structure of a joystick unit by way of an example.

FIG. 8 is a diagram for describing the behaviors (the steering states and the propulsive force generating states) of the engine outboard motor and the electric outboard motor according to a watercraft maneuvering mode and an operation mode (propulsion device mode).

FIG. 9 is a diagram for describing an exemplary engine speed control operation to be performed in an extender mode when the speed of the watercraft is zero.

FIG. 10 is a diagram for describing another exemplary engine speed control operation to be performed to change an engine speed according to the watercraft speed in the extender mode.

FIG. 11 is a flowchart for describing an exemplary process to be performed for the engine speed control in the extender mode.

FIG. 12 is a diagram for describing an estimation of a watercraft log speed.

### DETAILED DESCRIPTION OF THE EXAMPLE EMBODIMENTS

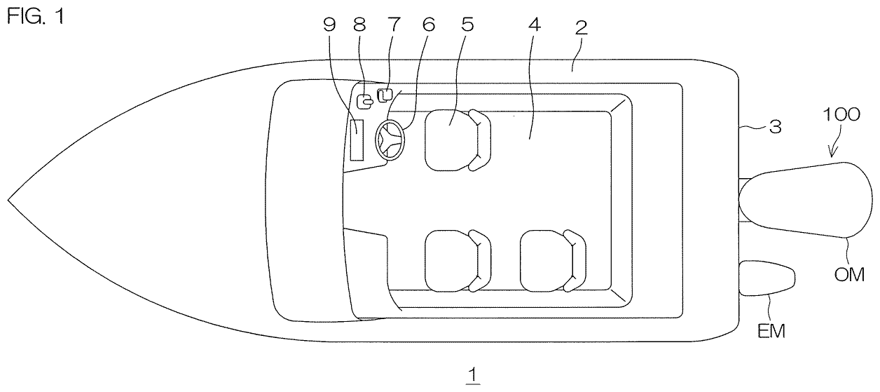

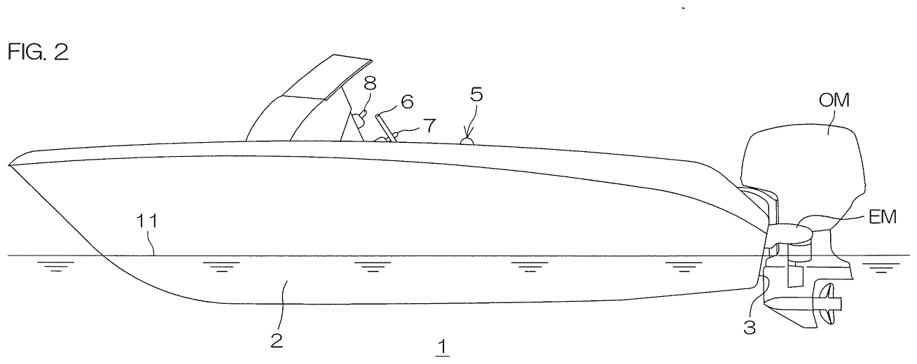

FIG. 1 is a plan view showing an exemplary construction of a watercraft 1 mounted with a watercraft propulsion system 100 according to an example embodiment of the present invention. FIG. 2 is a port side view of the watercraft 1 as seen from a left side with respect to the bow direction of the watercraft 1.

The watercraft 1 includes a hull 2, an engine outboard motor OM attached to the hull 2, and an electric outboard motor EM attached to the hull 2. The engine outboard motor OM and the electric outboard motor EM are examples of the propulsion devices. The engine outboard motor OM is an exemplary main propulsion device. The electric outboard motor EM is an exemplary auxiliary propulsion device having a lower rated output than the main propulsion device. The engine outboard motor OM is an example of the engine propulsion device including an engine as a power source. The electric outboard motor EM is an example of the electric propulsion device including an electric motor as a power source.

In the present example embodiment, the engine outboard motor OM and the electric outboard motor EM are attached to the stern 3 of the hull 2. More specifically, the engine outboard motor OM and the electric outboard motor EM are disposed side by side transversely of the hull 2 on the stern 3. In the present example embodiment, the engine outboard motor OM is disposed on a transversely middle portion of the stern 3, and the electric outboard motor EM is disposed outward (leftward) of the transversely middle portion of the stern 3.

A usable space 4 for passengers is provided inside the hull 2. A helm seat 5 is provided in the usable space 4. A steering wheel 6, a remote control lever 7, a joystick 8, a gauge 9 (display panel) and the like are provided in association with the helm seat 5. The steering wheel 6 is an operator operable by a user (an operator) to change the course of the watercraft 1. The remote control lever 7 is an operator operable by the user to change the magnitude (output) and the direction (forward or reverse direction) of the propulsive force of the engine outboard motor OM, and corresponds to an acceleration operator. The joystick 8 is an operator operable instead of the steering wheel 6 and the remote control lever 7 by the user to maneuver the watercraft 1.

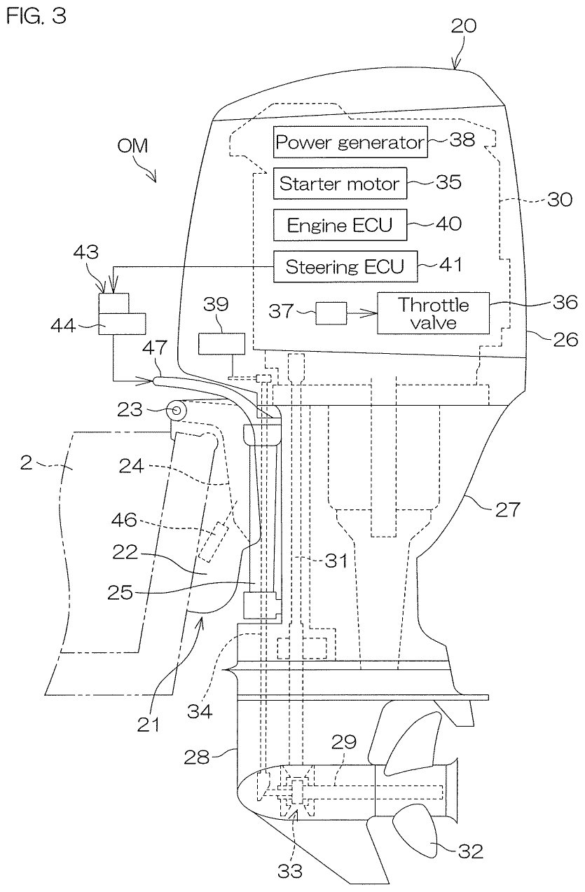

FIG. 3 is a side view showing the structure of the engine outboard motor OM by way of example. The engine outboard motor OM include a propulsion unit 20, and an attachment mechanism 21 that attaches the propulsion unit 20 to the hull 2. The attachment mechanism 21 includes a clamp bracket 22 detachably fixed to a transom plate provided on the stern 3 of the hull 2, and a swivel bracket 24 pivotally connected to the clamp bracket 22 about a tilt shaft 23 (horizontal pivot shaft). The propulsion unit 20 is pivotally attached to the swivel bracket 24 about a steering shaft 25. Thus, a steering angle (the azimuth angle of a propulsive force direction with respect to the center line of the hull 2) can be changed by pivoting the propulsion unit 20 about the steering shaft 25. Further, the trim angle of the propulsion unit 20 can be changed by pivoting the swivel bracket 24 about the tilt shaft 23. The trim angle is an angle at which the engine outboard motor OM is attached to the hull 2.

The housing of the propulsion unit 20 includes an engine cover (top cowling) 26, an upper case 27, and a lower case 28. An engine 30 is provided as a prime mover in the engine cover 26 with the axis of its crank shaft extending vertically. A drive shaft 31 to transmit power is connected to the lower end of the crank shaft of the engine 30, and extends vertically through the upper case 27 into the lower case 28.

A propeller 32 is provided as a rotatable propulsion member at the lower rear side of the lower case 28. A propeller shaft 29, which is the rotation shaft of the propeller 32, extends horizontally through the lower case 28. The rotation of the drive shaft 31 is transmitted to the propeller shaft 29 via a shift mechanism 33.

The shift mechanism 33 includes a plurality of shift positions (shift states) including a forward shift position, a reverse shift position, and a neutral shift position. The neutral shift position corresponds to a cutoff state in which the rotation of the drive shaft 31 is not transmitted to the propeller shaft 29. The forward shift position corresponds to a state such that the rotation of the drive shaft 31 is transmitted to the propeller shaft 29 so as to rotate the propeller shaft 29 in a forward drive rotation direction. The reverse shift position corresponds to a state such that the rotation of the drive shaft 31 is transmitted to the propeller shaft 29 so as to rotate the propeller shaft 29 in a reverse drive rotation direction. The forward drive rotation direction is such that the propeller 32 is rotated so as to apply a forward propulsive force to the hull 2. The reverse drive rotation direction is such that the propeller 32 is rotated so as to apply a reverse propulsive force to the hull 2. The shift position of the shift mechanism 33 is switched by a shift rod 34. The shift rod 34 extends vertically parallel or substantially parallel to the drive shaft 31, and is pivotable about its axis to operate the shift mechanism 33.

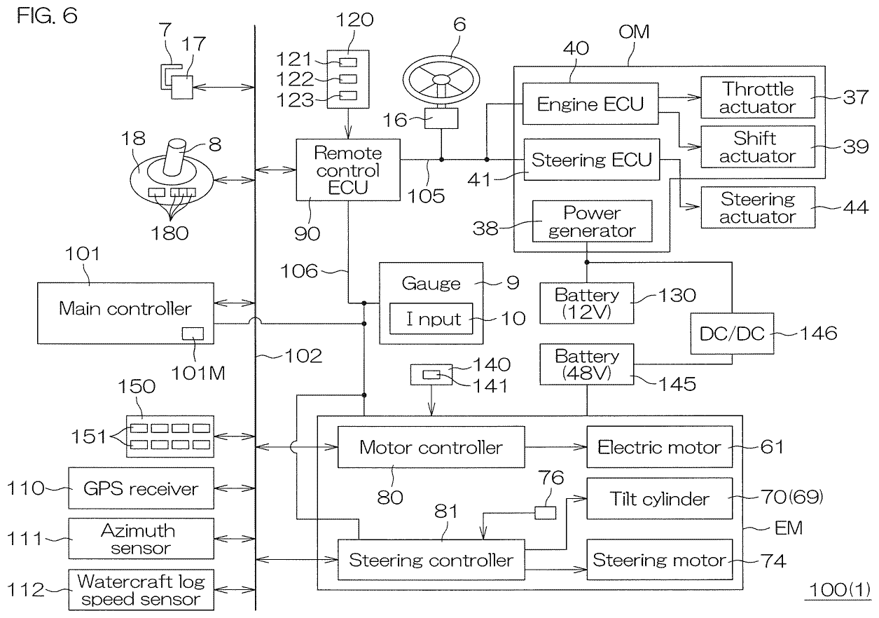

A starter motor 35 to start the engine 30, and a power generator 38 to generate electric power by the power of the engine 30 after the startup of the engine 30 are provided in association with the engine 30. The starter motor 35 is controlled by an engine ECU (Electronic Control Unit) 40. The electric power generated by the power generator 38 is supplied to electric components provided in the engine outboard motor OM and, in addition, is used to charge batteries 130, 145 (see FIG. 6) accommodated in the hull 2 (see FIGS. 1 and 2). Further, a throttle actuator 37 is provided in association with the engine 30. The throttle actuator 37 actuates the throttle valve 36 of the engine 30 so as to change the throttle opening degree of the engine 30 to change the intake air amount of the engine 30. The throttle actuator 37 may be an electric motor. The operation of the throttle actuator 37 is controlled by the engine ECU 40.

A shift actuator 39 to change the shift position of the shift mechanism 33 is provided in association with the shift rod 34. The shift actuator 39 is, for example, an electric motor, and the operation of the shift actuator 39 is controlled by the engine ECU 40.

Further, a steering rod 47 is fixed to the propulsion unit 20, and a steering device 43 to be driven according to the operation of the steering wheel 6 (see FIG. 1) is connected to the steering rod 47. The steering device 43 pivots the propulsion unit 20 about the steering shaft 25 to perform a steering operation. The steering device 43 includes a steering actuator 44. The steering actuator 44 is controlled by a steering ECU 41. The steering ECU 41 may be provided in the propulsion unit 20. The steering actuator 44 may be an electric motor, or may be a hydraulic actuator.

A tilt/trim actuator 46 is provided between the clamp bracket 22 and the swivel bracket 24. The tilt/trim actuator 46 includes, for example, a hydraulic cylinder, and is controlled by the engine ECU 40. The tilt/trim actuator 46 pivots the swivel bracket 24 about the tilt shaft 23 to pivot the propulsion unit 20 about the tilt shaft 23.

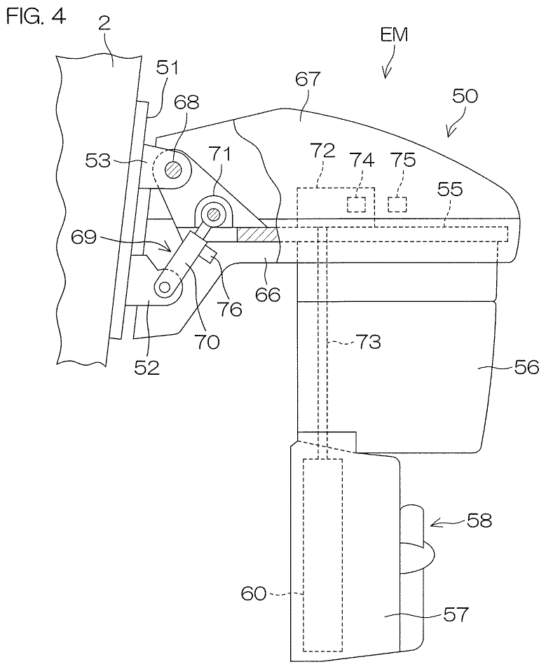

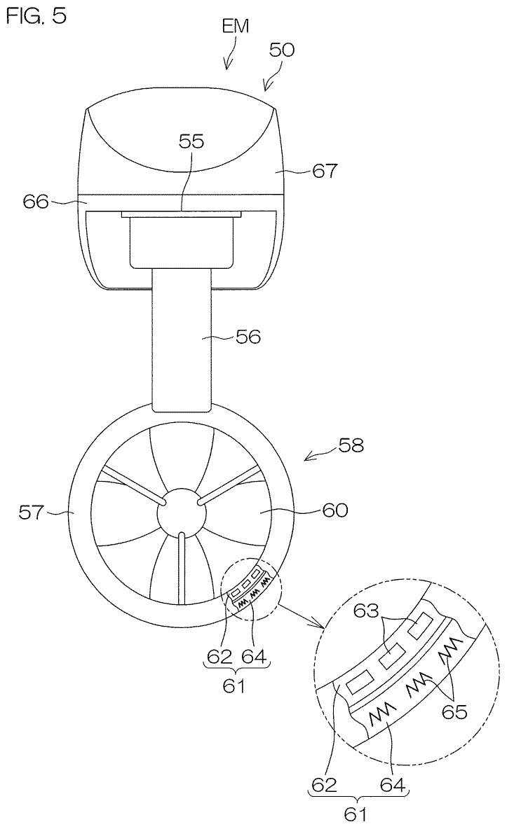

FIG. 4 is a side view showing the structure of the electric outboard motor EM by way of an example, and FIG. 5 is a rear view of the electric outboard motor EM as seen from the rear side of the watercraft 1.

The electric outboard motor EM includes a bracket 51 attached to the hull 2, and a propulsion device body 50. The propulsion device body 50 is supported by the bracket 51. The propulsion device body 50 includes a base 55 supported by the bracket 51, an upper housing 56 extending downward from the base 55, a tubular (duct-shaped) lower housing 57 disposed below the upper housing 56, and a drive unit 58 disposed in the lower housing 57. The propulsion device body 50 further includes a cover 66 that covers the base 55 from the lower side, and a cowl 67 that covers the base 55 from the upper side. A tilt unit 69 and a steering unit 72 are accommodated in a space defined by the cover 66 and the cowl 67. Further, a buzzer 75 that generates sound when the tilt unit 69 is actuated may be accommodated in this space.

The drive unit 58 includes a propeller 60, and an electric motor 61 that rotates the propeller 60. The electric motor 61 includes a tubular rotor 62 to which the propeller 60 is fixed radially inward thereof, and a tubular stator 64 that surrounds the rotor 62 from the radially outside. The stator 64 is fixed to the lower housing 57, and the rotor 62 is supported rotatably with respect to the lower housing 57. The rotor 62 includes a plurality of permanent magnets 63 disposed circumferentially thereof. The stator 64 includes a plurality of coils 65 disposed circumferentially thereof. The rotor 62 can be rotated by energizing the coils 65 such that the propeller 60 is correspondingly rotated to generate a propulsive force.

The tilt unit 69 includes a tilt cylinder 70 as a tilt actuator. The tilt cylinder 70 may be a hydraulic cylinder of an electric pump type to pump a hydraulic oil with an electric pump. One of opposite ends of the tilt cylinder 70 is connected to the lower support portion 52 of the bracket 51, and the other end of the tilt cylinder 70 is connected to the base 55 via a cylinder connection bracket 71. A tilt shaft 68 is supported by the upper support portion 53 of the bracket 51, and the base 55 is pivotally connected to the bracket 51 via the tilt shaft 68 about the tilt shaft 68. The tilt shaft 68 extends transversely of the hull 2 so that the base 55 can be pivoted upward and downward. Thus, the propulsion device body 50 can be pivoted upward and downward about the tilt shaft 68.

An expression “tilt-up” means that the propulsion device body 50 is pivoted upward about the tilt shaft 68, and an expression “tilt-down” means that the propulsion device body 50 is pivoted downward about the tilt shaft 68. The tilt cylinder 70 is driven to be extended and retracted such that the tilt-up and the tilt-down can be achieved. The propeller 60 is moved up to an above-water position by the tilt-up such that the propulsion device body 50 can be brought into a tilt-up state. Further, the propeller 60 is moved down to an underwater position by the tilt-down such that the propulsion device body 50 can be brought into a tilt-down state. Thus, the tilt unit 69 is an exemplary lift device that moves the propeller 60 up and down.

A tilt angle sensor 76 detects a tilt angle (i.e., the angle of the propulsion device body 50 with respect to the bracket 51) to detect the tilt-up state and the tilt-down state of the propulsion device body 50. The tilt angle sensor 76 may be a position sensor to detect the position of the actuation rod of the tilt cylinder 70.

The steering unit 72 includes a steering shaft 73 connected to the lower housing 57 and the upper housing 56, and a steering motor 74. The steering motor 74 is an exemplary steering actuator to generate a drive force to pivot the steering shaft 73 about its axis. The steering unit 72 may further include a reduction gear to decelerate the rotation of the steering motor 74 and to transmit the rotation of the steering motor 74 to the steering shaft 73. Thus, the lower housing 57 and the upper housing 56 are pivoted about the steering shaft 73 by driving the steering motor 74 such that the direction of the propulsive force generated by the drive unit 58 can be changed leftward and rightward. The upper housing 56 has a plate shape that extents anteroposteriorly of the hull 2 in a neutral steering position, and functions as a rudder plate to be steered by the steering unit 72.

FIG. 6 is a block diagram showing an exemplary configuration of the watercraft propulsion system 100 provided in the watercraft 1. The watercraft propulsion system 100 includes the engine outboard motor OM and the electric outboard motor EM.

The watercraft propulsion system 100 includes a main controller 101. The main controller 101 is connected to an onboard network 102 (CAN: Control Area Network) provided in the hull 2. A remote control unit 17, a remote control ECU 90, a joystick unit 18, a GPS (Global Positioning System) receiver 110, an azimuth sensor 111, and the like are connected to the onboard network 102. Further, a watercraft log speed sensor 112 may be connected to the onboard network 102. The engine ECU 40 and the steering ECU 41 are connected to the remote control ECU 90 via an outboard motor control network 105. The main controller 101 transmits and receives signals to/from various units connected to the onboard network 102 to control the engine outboard motor OM and the electric outboard motor EM, and further controls other units. The main controller 101 includes a plurality of control modes, and controls the units in predetermined manners according to the respective control modes.

A steering wheel unit 16 is connected to the outboard motor control network 105. The steering wheel unit 16 outputs an operation angle signal indicating the operation angle of the steering wheel 6 to the outboard motor control network 105. The operation angle signal is received by the remote control ECU 90 and the steering ECU 41. In response to the operation angle signal generated by the steering wheel unit 16 or a steering angle command applied from the remote control ECU 90, the steering ECU 41 correspondingly controls the steering actuator 44 to control the steering angle of the engine outboard motor OM.

The remote control unit 17 generates an operation position signal indicating the operation position of the remote control lever 7.

The joystick unit 18 generates an operation position signal indicating the operation position of the joystick 8, and generates an operation signal when one of operation buttons 180 of the joystick unit 18 is operated.

The remote control ECU 90 outputs a propulsive force command to the engine ECU 40 via the outboard motor control network 105. The propulsive force command includes a shift command that indicates the shift position of the shift mechanism 33, and an output command that indicates the output of the engine 30 (specifically, the engine speed). Further, the remote control ECU 90 outputs the steering angle command to the steering ECU 41 via the outboard motor control network 105.

The remote control ECU 90 performs different control operations according to different control modes of the main controller 101. In a control mode for watercraft maneuvering with the use of the steering wheel 6 and the remote control lever 7, for example, the propulsive force command (the shift command and the output command) is generated according to the operation position signal generated by the remote control unit 17, and is applied to the engine ECU 40 by the remote control ECU 90. Further, the remote control ECU 90 commands the steering ECU 41 to conform to the operation angle signal generated by the steering wheel unit 16. In a control mode for watercraft maneuvering without the use of the steering wheel 6 and the remote control lever 7, on the other hand, the remote control ECU 90 conforms to commands applied by the main controller 101. That is, the main controller 101 generates the propulsive force command (the shift command and the output command) and the steering angle command, which are outputted to the engine ECU 40 and the steering ECU 41, respectively, by the remote control ECU 90. In a control mode for watercraft maneuvering with the use of the joystick 8, for example, the main controller 101 generates the propulsive force command (the shift command and the output command) and the steering angle command according to the signals generated by the joystick unit 18. The magnitude and the direction (the forward direction or the reverse direction) of the propulsive force of the engine outboard motor OM and the steering angle of the engine outboard motor OM are controlled according to the propulsive force command (the shift command and the output command) and the steering angle command thus generated.

The engine ECU 40 drives the shift actuator 39 according to the shift command to control the shift position, and drives the throttle actuator 37 according to the output command to control the throttle opening degree. The steering ECU 41 controls the steering actuator 44 according to the steering angle command to control the steering angle of the engine outboard motor OM.

The electric outboard motor EM includes a motor controller 80 and a steering controller 81 connected to the onboard network 102, and is configured to be actuated in response to commands applied from the main controller 101. The main controller 101 applies a propulsive force command and a steering angle command to the electric outboard motor EM. The propulsive force command includes a shift command and an output command. The shift command is a rotation direction command that indicates stoppage of the propeller 60, the forward drive rotation of the propeller 60, or the reverse drive rotation of the propeller 60. The output command indicates a propulsive force to be generated, specifically the target value of the rotation speed of the propeller 60. The steering angle command indicates the target value of the steering angle of the electric outboard motor EM. The motor controller 80 controls the electric motor 61 according to the shift command (rotation direction command) and the output command. The steering controller 81 controls the steering motor 74 according to the steering angle command.

Further, the main controller 101 applies a tilt command to the steering controller 81 via the onboard network 102. The tilt command indicates the target value of the tilt angle of the electric outboard motor EM. The steering controller 81 actuates the tilt cylinder 70 according to the tilt command to tilt up or down the electric outboard motor EM to the target tilt angle. The detection signal of the tilt angle sensor 76 is inputted to the steering controller 81. Thus, the steering controller 81 can acquire information about the tilt angle of the propulsion device body 50, and transmit the tilt angle information to the main controller 101.

The GPS receiver 110, which is an exemplary GNSS (Global Navigation Satellite System) receiver, detects the position of the watercraft 1 by receiving radio waves from an artificial satellite orbiting the earth, and outputs position data indicating the position of the watercraft 1 and speed data indicating the moving speed of the watercraft 1. The main controller 101 acquires the position data and the speed data which are used to control and display the position and/or the azimuth of the watercraft 1. The speed data to be outputted by the GPS receiver 110 indicates the watercraft ground speed of the watercraft 1.

The azimuth sensor 111 detects the azimuth of the watercraft 1, and generates azimuth data which is used by the main controller 101.

The gauge 9 is connected to the main controller 101 via a control panel network 106. The gauge 9 is a display device that displays various information for the watercraft maneuvering. The gauge 9 is connected to the remote control ECU 90, the motor controller 80, and the steering controller 81 via the control panel network 106. Thus, the gauge 9 can display information about the operation state of the engine outboard motor OM, the operation state of the electric outboard motor EM, the position and/or the azimuth of the watercraft 1, and the like. The gauge 9 may include an input device 10 such as a touch panel and buttons. The user may operate the input device 10 to set various settings and give various commands such that operation signals are outputted to the control panel network 106.

A power switch unit 120 operable to turn on a power supply to the engine outboard motor OM and to start and stop the engine 30 is connected to the remote control ECU 90. The power switch unit 120 includes a power switch 121 operable to turn on and off the power supply to the engine outboard motor OM, a start switch 122 operable to start the engine 30, and a stop switch 123 operable to stop the engine 30.

With the power switch 121 turned on, the remote control ECU 90 performs a power supply control to control the power supply to the engine outboard motor OM. Specifically, a power supply relay (not shown) provided between the battery 130 (e.g., 12 V) and the engine outboard motor OM is turned on. When the start switch 122 is operated with the power supply to the engine outboard motor OM turned on, the remote control ECU 90 applies a start command to the engine ECU 40. Thus, the engine ECU 40 actuates the starter motor 35 (see FIG. 3) to start the engine 30. During the operation of the engine 30, the battery 130 is charged with the electric power generated by the power generator 38 (see FIG. 3). When the stop switch 123 is operated during the operation of the engine, the remote control ECU 90 applies an engine stop command to the engine ECU 40. In response to the engine stop command, the engine ECU 40 performs a stop control operation to stop the engine 30. Engine outboard motor state information indicating whether or not the power supply to the engine outboard motor OM is turned on and whether or not the engine 30 is in operation is applied to the main controller 101 via the onboard network 102 by the remote control ECU 90.

A power switch unit 140 operable to turn on and off a power supply to the electric outboard motor EM is connected to the electric outboard motor EM. By turning on and off a power switch 141 provided in the power switch unit 140, a circuit connected between the electric outboard motor EM and the battery 145 (e.g., 48 V) that supplies the electric power to the electric outboard motor EM is closed and opened to turn on and off the power supply to the electric outboard motor EM.

Electric outboard motor state information indicating whether or not the power supply to the electric outboard motor EM is turned on, i.e., whether or not the electric outboard motor EM is in a drivable state, is applied to the main controller 101 via the onboard network 102 by the motor controller 80. The battery 145 can receive the electric power generated by the power generator 38 (see FIG. 3) of the engine outboard motor OM via a DC/DC convertor 146 (voltage transformer).

Further, an application switch panel 150 is connected to the onboard network 102. The application switch panel 150 includes a plurality of function switches 151 operable to apply predefined function commands. For example, the function switches 151 may include switches for automatic watercraft maneuvering commands. Specific examples of the function switches 151 may include switches for an automatic steering function of maintaining the azimuth of the watercraft 1, an automatic steering function of maintaining the course of the watercraft 1, an automatic steering function of causing the watercraft 1 to pass through a plurality of checkpoints sequentially, and an automatic steering function of causing the watercraft 1 to travel along a predetermined pattern (zig-zag pattern, spiral pattern or the like). A function for the tilt-up or the tilt-down of the electric outboard motor EM may be assigned to one of the function switches 151.

The main controller 101 is configured or programmed to control the engine outboard motor OM and the electric outboard motor EM in a plurality of control modes. The control modes include a plurality of operation modes (propulsion device modes) each defined by the state of the engine outboard motor OM and the state of the electric outboard motor EM. Specifically, the operation modes include an electric mode, an engine mode, a dual mode, and an extender mode. The main controller 101 operates according to any one of the operation modes (control modes) based on the engine outboard motor state information and the electric outboard motor state information.

In the electric mode, the power supply to the electric outboard motor EM is turned on, and the power supply to the engine outboard motor OM is turned off. That is, only the electric outboard motor EM generates the propulsive force in the electric mode. In the engine mode, the engine 30 is in operation with the power supply to the engine outboard motor OM turned on, and the power supply to the electric outboard motor EM is turned off. That is, only the engine outboard motor OM generates the propulsive force in the engine mode. In the dual mode and the extender mode, the power supply to the electric outboard motor EM is turned on, and the engine 30 of the engine outboard motor OM is in operation. In the dual mode, the propulsive force generated by the engine outboard motor OM and the propulsive force generated by the electric outboard motor EM are both utilized. In the extender mode, only the propulsive force generated by the electric outboard motor EM is utilized, and the engine 30 is driven to generate the electric power to charge the battery 145. In the electric mode and the extender mode, the electric outboard motor EM generates a propulsive force. The user may set a setting or give a command to select the dual mode or the extender mode. For example, the user may operate the input device 10 provided in the gauge 9 to set the setting or give the command. Further, the dual mode and the extender mode may be automatically switched therebetween based on a required propulsive force magnitude. That is, the extender mode may be automatically selected when the required propulsive force magnitude is relatively small, and the dual mode may be automatically selected when the required propulsive force magnitude is relatively great.

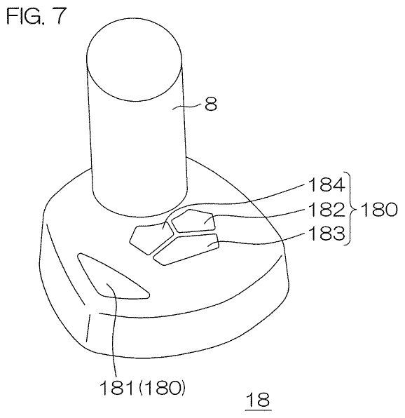

FIG. 7 is a perspective view showing the structure of the joystick unit 18 by way of an example. The joystick unit 18 includes the joystick 8, which can be inclined forward, backward, leftward, and rightward (i.e., in all 360-degree directions) and can be twisted about its axis. In the present example embodiment, the joystick unit 18 further includes a plurality of operation buttons 180. The operation buttons 180 include a joystick button 181 and holding mode setting buttons 182 to 184.

The joystick button 181 is an operator operable by the user to select a control mode (watercraft maneuvering mode) utilizing the joystick 8, i.e., a joystick mode.

The holding mode setting buttons 182, 183, 184 are operation buttons operable by the user to select position/azimuth holding control modes (exemplary holding modes). More specifically, the holding mode setting button 182 is operated to select a fixed point holding mode (STAYPOINT™) in which the position and the bow azimuth (or the stern azimuth) of the watercraft 1 are maintained. The holding mode setting button 183 is operated to select a position holding mode (FISHPOINT™) in which the position of the watercraft 1 is maintained but the bow azimuth (or the stern azimuth) of the watercraft 1 is not maintained. The holding mode setting button 184 is operated to select an azimuth holding mode (DRIFTPOINT™) in which the bow azimuth (or the stern azimuth) of the watercraft 1 is maintained but the position of the watercraft 1 is not maintained.

The control mode of the main controller 101 can be classified into an ordinary mode, the joystick mode, or the holding mode in terms of operation.

In the ordinary mode, a steering control operation is performed according to the operation angle signal generated by the steering wheel unit 16, and a propulsive force control operation is performed according to the operation signal (operation position signal) of the remote control lever 7. In the present example embodiment, the ordinary mode is a default control mode of the main controller 101. In the steering control operation, specifically, the steering ECU 41 drives the steering actuator 44 according to the operation angle signal generated by the steering wheel unit 16 or the steering angle command applied from the remote control ECU 90. Thus, the body of the engine outboard motor OM is steered leftward and rightward such that the propulsive force direction is changed leftward and rightward with respect to the hull 2. In the propulsive force control operation, specifically, the engine ECU 40 drives the shift actuator 39 and the throttle actuator 37 according to the propulsive force command (the shift command and the output command) applied to the engine ECU 40 by the remote control ECU 90. Thus, the shift position of the engine outboard motor OM is set to the forward shift position, the reverse shift position, or the neutral shift position, and the engine output (specifically, the engine speed) is changed.

In the joystick mode, the steering control operation and the propulsive force control operation are performed according to the operation signal of the joystick 8 of the joystick unit 18.

In the joystick mode, the steering control operation and the propulsive force control operation are performed on the engine outboard motor OM if the engine outboard motor OM is in a propulsive force generatable state. That is, the main controller 101 applies the steering angle command and the propulsive force command to the remote control ECU 90, and the remote control ECU 90 applies the steering angle command and the propulsive force command to the steering ECU 41 and the engine ECU 40, respectively.

In the joystick mode, the steering control operation and the propulsive force control operation are performed on the electric outboard motor EM if the electric outboard motor EM is in a propulsive force generatable state. In the steering control operation on the electric outboard motor EM, specifically, the steering controller 81 drives the steering unit 72 according to the steering angle command applied to the steering controller 81 of the electric outboard motor EM by the main controller 101. Thus, the drive unit 58 and the upper housing 56 of the electric outboard motor EM are pivoted leftward and rightward such that the propulsive force direction is changed leftward and rightward with respect to the hull 2. In the propulsive force control operation on the electric outboard motor EM, specifically, the motor controller 80 controls the rotation direction and the rotation speed of the electric motor 61 according to the propulsive force command (the shift command and the output command) applied to the motor controller 80 of the electric outboard motor EM by the main controller 101. Thus, the rotation direction of the propeller 60 is set to a forward drive rotation direction or a reverse drive rotation direction, and the rotation speed of the propeller 60 is changed.

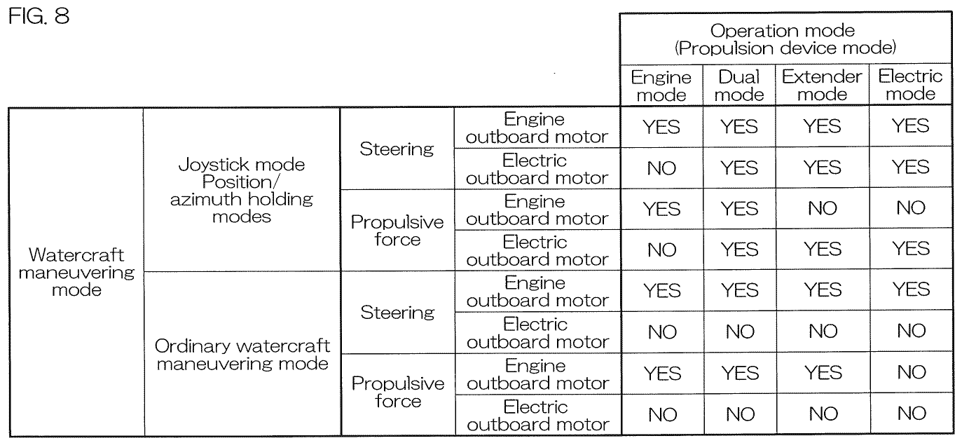

FIG. 8 is a diagram for describing the behaviors (the steering states and the propulsive force generating states) of the engine outboard motor OM and the electric outboard motor EM according to the watercraft maneuvering mode and the operation mode (propulsion device mode).

In the ordinary watercraft maneuvering mode in which the watercraft maneuvering operation is performed by operating the steering wheel 6 and the remote control lever 7, the engine outboard motor OM is steered according to the operation of the steering wheel 6, and the electric outboard motor EM does not respond to the operation of the steering wheel 6 in any of the operation modes. Where the engine mode, the dual mode, or the extender mode is effected in the ordinary watercraft maneuvering mode, on the other hand, the engine outboard motor OM actuates its shift mechanism 33 in response to the operation of the remote control lever 7. In the extender mode, only the electric outboard motor EM primarily generates the propulsive force, but the user can utilize the propulsive force of the engine outboard motor OM, as required, by operating the remote control lever 7. Where the electric mode is effected in the ordinary watercraft maneuvering mode, the engine outboard motor OM does not respond to the operation of the remote control lever 7. In the ordinary watercraft maneuvering mode, the electric outboard motor EM does not respond to the operation of the remote control lever 7 in any of the operation modes.

Next, description will be given to a case in which the watercraft maneuvering mode is one of the joystick mode and the position/azimuth holding control modes. In this case, the main controller 101 generates the propulsive force command (the shift command and the output command) and the steering angle command.

In the engine mode and the dual mode, the engine outboard motor OM first generates the propulsive force in response to the propulsive force command. In the extender mode, the engine outboard motor OM basically generates no propulsive force. In the electric mode, the engine outboard motor OM generates no propulsive force. On the other hand, the engine outboard motor OM performs the steering operation in response to the steering angle command in any of the operation modes. A sailing resistance due to the engine outboard motor OM can be reduced by thus performing the steering operation in the extender mode and the dual mode.

In the engine mode, the electric outboard motor EM responds to neither the propulsive force command nor the steering angle command. In the dual mode, the extender mode, and the electric mode, the electric outboard motor EM responds to both the propulsive force command and the steering angle command.

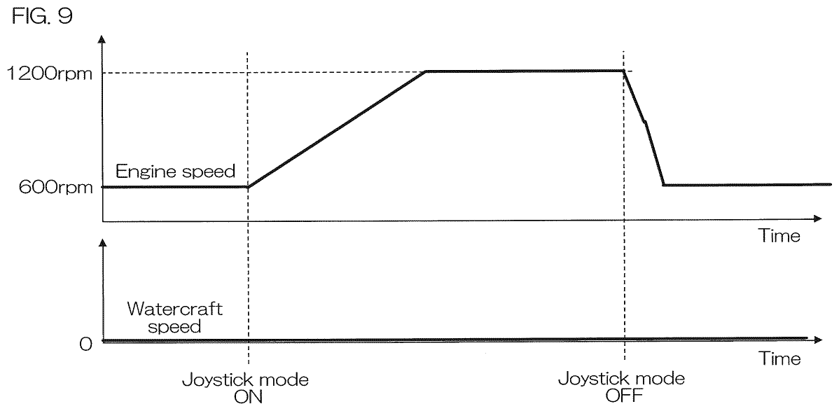

FIG. 9 is a diagram for describing an exemplary engine speed control operation to be performed in the extender mode when the watercraft speed is zero. The extender mode is an operation mode to be selected with the power supplies to the engine outboard motor OM and the electric outboard motor EM both turned on. The extender mode can be selected, for example, by operating the input device 10 while viewing the gauge 9 (e.g., by operating a button displayed on the gauge 9).

When the user operates the joystick button 181 to select the joystick mode in the extender mode, the main controller 101 applies an engine speed increasing command to the engine outboard motor OM in response to the operation of the joystick button 181. Thus, the engine speed of the engine outboard motor OM is increased from a predetermined idling engine speed (e.g., 600 rpm) to a predetermined target power generation engine speed level (e.g., 1,200 rpm). This increases the power generation amount of the power generator 38 making it possible to supply sufficient electric power to the battery 145 and to operate the electric outboard motor EM by the electric power supplied from the battery 145. When the user performs a predetermined joystick mode ending operation to end the joystick mode, the main controller 101 applies an engine speed return command to the engine outboard motor OM in response to the joystick mode ending operation. Thus, the engine speed of the engine outboard motor OM is reduced to the predetermined idling engine speed. The joystick mode ending operation is performed by operating the joystick button 181. In addition, when the steering wheel 6 or the remote control lever 7 is operated, the main controller 101 may end the joystick mode to switch its control mode to the ordinary watercraft maneuvering mode.

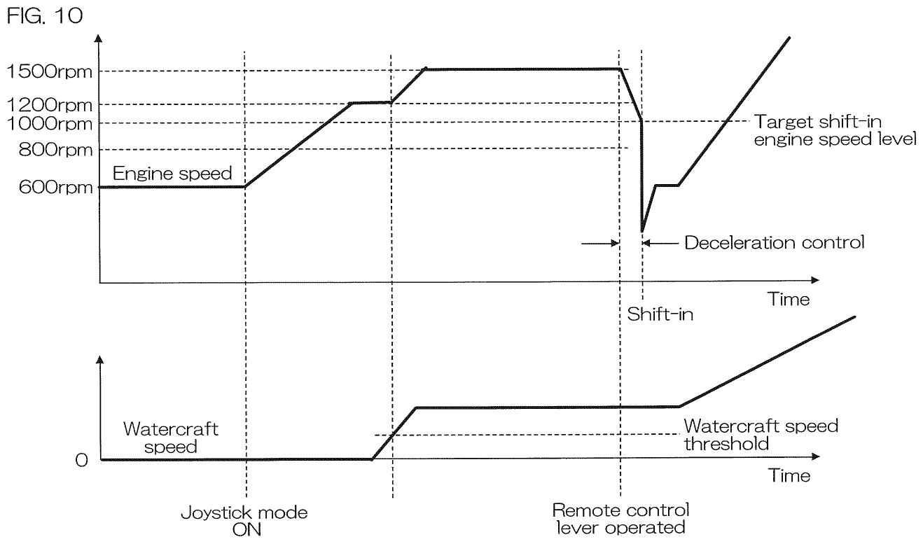

FIG. 10 is a diagram for describing another exemplary engine speed control operation to be performed in the extender mode when the engine speed is changed according to the watercraft speed. When the user operates the joystick button 181 to select the joystick mode in the extender mode, the main controller 101 applies the engine speed increasing command to the engine outboard motor OM in response to the operation of the joystick button 181. Thus, the engine speed of the engine outboard motor OM is increased from the predetermined idling engine speed (e.g., 600 rpm) to the predetermined target power generation engine speed level (e.g., 1,200 rpm). This increases the power generation amount of the power generator 38 making it possible to supply sufficient electric power to the battery 145 and to operate the electric outboard motor EM by the electric power supplied from the battery 145.

When the user operates the joystick 8 the electric outboard motor EM correspondingly generates the propulsive force such that the watercraft speed is increased. Then, the main controller 101 applies the engine speed increasing command to the engine outboard motor OM as corresponding to the watercraft speed. More specifically, when the watercraft speed is not higher than a predetermined watercraft speed threshold, the main controller 101 applies a command of the target power generation engine speed level to the engine outboard motor OM. When the watercraft speed exceeds the watercraft speed threshold, the main controller 101 applies a command of a target engine speed level higher than the target power generation engine speed level to the engine outboard motor OM. Thus, the engine speed of the engine outboard motor OM is increased to the engine speed level (e.g., 1,500 rpm) higher than the target power generation engine speed level (e.g., 1,200 rpm). Thus, the power generator 38 can generate greater electric power. Therefore, even if the power consumption of the electric outboard motor EM is increased, the battery 145 can be charged sufficiently for power consumption.

The target power generation engine speed level is preferably set so as to provide quiet sailing of the watercraft 1 by utilizing the electric outboard motor EM while preventing the engine 30 from generating an excessively loud engine sound. Since requirements for quiet sailing and the like vary depending on the user, it is preferred that the target power generation engine speed level can be variably set, for example, by operating the input device 10 of the gauge 9. The target power generation engine speed level may be continuously variably set or may be variably set stepwise to a plurality of levels. More specifically, the target power generation engine speed level may be variably set to a first target power generation engine speed level (e.g., 800 rpm), a second target power generation engine speed level (e.g., 1,000 rpm) higher than the first target power generation engine speed level, or a third target power generation engine speed level (e.g., 1,200 rpm) higher than the second target power generation engine speed level. The number of the target power generation engine speed levels to be variably set may be two or may be four or more.

On the other hand, the water sound and/or the wind sound of the hull 2 are increased due to the increase in the watercraft speed, so that the allowable level of the engine sound is correspondingly increased. In this example embodiment, therefore, the engine speed is increased to increase the power generation amount of the power generator 38 (i.e., the charge amount of the battery 145) as the watercraft speed increases. The increase in the engine speed is preferably set in consideration of the loudness of the engine sound, the heat generation amount of the power generator 38, and vibrations caused by the operation of the engine 30.

When the user performs an acceleration operation on the remote control lever 7, the watercraft maneuvering mode is switched from the joystick mode to the ordinary watercraft maneuvering mode. At this time, the main controller 101 performs a deceleration control by applying an engine speed reducing command to the engine outboard motor OM to reduce the engine speed of the engine outboard motor OM to not higher than a target shift-in engine speed level. More specifically, the main controller 101 computes a deceleration period required for the reduction of the engine speed from the current level to not higher than the target shift-in engine speed level, and applies the engine speed reducing command to the engine outboard motor OM for the deceleration period. Thus, the engine ECU 40 reduces the engine speed to the target shift-in engine speed level, and then allows the shift mechanism 33 to shift in. The shift-in of the shift mechanism 33 instantaneously reduces the engine speed due to the inertia of the propeller 32 and the like. Then, the engine speed is increased according to a command from the remote control lever 7 such that the watercraft speed is correspondingly increased. Thus, the propulsive force generated by the engine outboard motor OM can be utilized as required in the extender mode.

The target power generation engine speed level may be set to an engine speed level (the third target power generation engine speed level, e.g., 1,200 rpm) that is higher than the target shift-in engine speed level (e.g., 1,000 rpm). Alternatively, the target power generation engine speed level may be set to an engine speed level (the second target power generation engine speed level, e.g., 1,000 rpm) that is equal to the target shift-in engine speed level. Further, the target power generation engine speed level may be set to an engine speed level (the first target power generation engine speed level, e.g., 800 rpm) that is lower than the target shift-in engine speed level. Where the target power generation engine speed level is not higher than the target shift-in engine speed level, the shift mechanism 33 may be allowed to shift in immediately without performing the deceleration control for the reduction of the engine speed to not higher than the target shift-in engine speed level, even if the remote control lever 7 is operated during the operation of the engine 30 at the target power generation engine speed level.

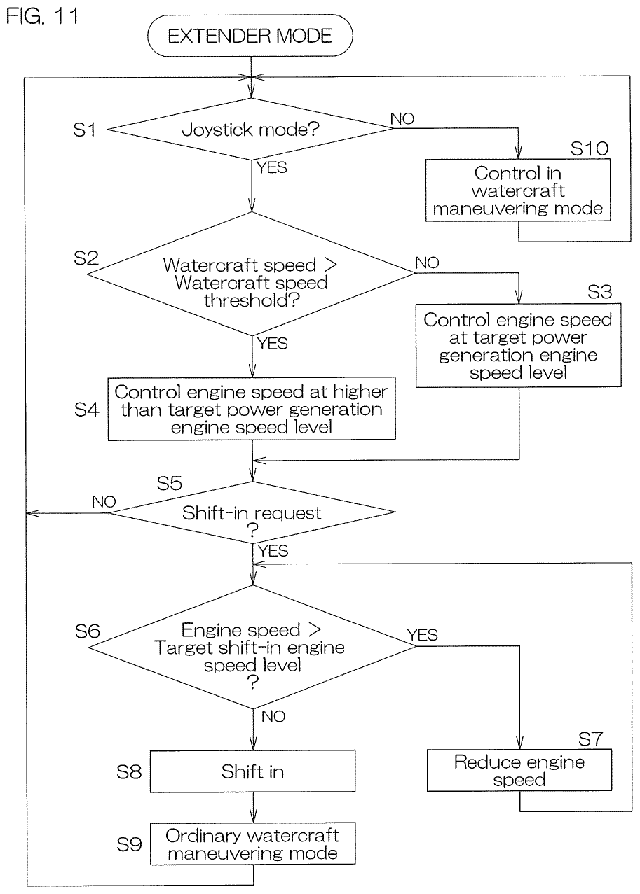

FIG. 11 is a flowchart for describing an exemplary process to be performed for the engine speed control in the extender mode. If the joystick mode is selected by operating the joystick button 181 (YES in Step S1), the main controller 101 increases the engine speed of the engine outboard motor OM to the target power generation engine speed level (Steps S3, S4). The main controller 101 monitors the watercraft speed, and controls the engine speed to the target power generation engine speed level or higher according to the watercraft speed. The engine speed may be increased continuously or stepwise according to the watercraft speed. In the process shown in FIG. 11, the engine speed is changed stepwise by way of example.

Specifically, if the watercraft speed is not higher than the predetermined watercraft speed threshold (NO in Step S2), the engine speed is kept at the target power generation engine speed level (Step S3). If the watercraft speed is higher than the watercraft speed threshold, the engine speed is kept higher than the target power generation engine speed level (Step S4). Hysteresis may be introduced into the engine speed increase associated with the increase in the watercraft speed and into the engine speed reduction associated with the reduction in the watercraft speed by providing two watercraft speed thresholds.

Where the shift mechanism 33 of the engine outboard motor OM should be allowed to shift in with the remote control lever 7 operated, i.e., where a shift-in request is issued, on the other hand, the main controller 101 compares the current engine speed with the target shift-in engine speed level (Step S6). If the current engine speed is higher, the main controller 101 applies the engine speed reducing command to the engine outboard motor OM to reduce the engine speed to the target shift-in engine speed level (Step S7). Thus, the engine speed is reduced to not higher than the target shift-in engine speed level (NO in Step S6), and then the shift mechanism 33 of the engine outboard motor OM is allowed to shift in (Step S8). This prevents the loud sound and the vibrations which may otherwise occur at the shift-in of the shift mechanism 33. In this case, the watercraft maneuvering mode is switched to the ordinary watercraft maneuvering mode (Step S9), and the joystick mode ends (NO in Step S1). Then, the engine speed control operation is performed according to the ordinary watercraft maneuvering mode (Step S10).

The watercraft speed to which the main controller 101 refers for the aforementioned control process may be the watercraft ground speed. For example, the speed data generated by the GPS receiver 110 may be used as the watercraft ground speed, or the watercraft ground speed may be determined by differentiating the position data generated by the GPS receiver 110. By increasing or reducing the engine speed based on the watercraft ground speed, the engine speed can be properly controlled mainly according to the loudness of the wind sound during the operation in the extender mode.

The watercraft speed to which the main controller 101 refers for the aforementioned control process may be a watercraft log speed. The watercraft log speed may be determined by the watercraft log speed sensor 112 (see FIG. 6) such as Pitot tube, or may be estimated from the operation state of the propulsion device.

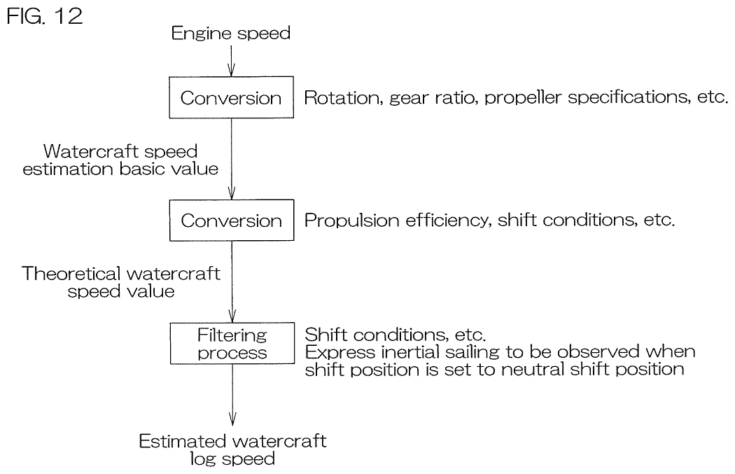

The estimation is shown in FIG. 12 by way of an example. That is, the engine speed of the engine outboard motor OM can be converted to a watercraft speed estimation basic value based on a gear ratio and propeller specifications. The watercraft speed estimation basic value can be converted to a theoretical watercraft speed value based on shift conditions and the like in consideration of a propulsion efficiency. Further, the theoretical watercraft speed value can be converted to a watercraft log speed estimation value by performing a filtering process on the theoretical watercraft speed value based on the shift conditions and the like. The filtering process may be such as to express inertial sailing to be observed when the shift position of the shift mechanism 33 is set to the neutral shift position. The watercraft log speed estimation value thus determined may be used as the watercraft log speed for the engine speed increasing/reducing control.

During the operation in the extender mode, the engine speed can be properly controlled mainly according to the loudness of the water sound by increasing or reducing the engine speed based on the watercraft log speed.

As described above, the watercraft propulsion system 100 according to this example embodiment includes the engine outboard motor OM as the engine propulsion device including the power generator 38, the electric outboard motor EM as the electric propulsion device connected to the battery 145 charged by the power generator 38, and the main controller 101. The main controller 101 includes the plurality of operation modes, one of which is the extender mode in which the electric outboard motor EM generates the propulsive force and the power generator 38 of the engine outboard motor OM is driven to charge the battery 145. In the extender mode, the main controller 101 changes the engine speed of the engine outboard motor OM according to the watercraft speed.

The electric outboard motor EM is a propulsion device that is convenient when the watercraft 1 is quietly sailed at a lower speed. In the extender mode, the battery 145 that supplies the electric power to the electric outboard motor EM is charged by the power generator 38 of the engine outboard motor OM so as to extend the sailing range for which the watercraft 1 can be sailed by utilizing the electric outboard motor EM. If the engine sound is loud, however, the quietness of the watercraft 1 is deteriorated. In this aspect, it is preferred to keep the engine speed at a lower level. When the watercraft speed is high, on the other hand, the water sound and the wind sound generated by the hull 2 are loud. Thus, the product value of the watercraft 1 is not significantly influenced by the generation of a relatively loud engine sound. In addition, the electric outboard motor EM is liable to have an increased power consumption when the watercraft speed is high. Therefore, the power generator 38 preferably has a greater battery charging amount for the charging of the battery 145.

In this example embodiment, therefore, the engine speed of the engine outboard motor OM is changed according to the watercraft speed. This makes it possible to properly charge the battery 145 by the power generator 38 of the engine outboard motor OM without significantly influencing the product value of the watercraft 1.

In this example embodiment, the main controller 101 controls the engine speed of the engine outboard motor OM at the predetermined target power generation engine speed level when the watercraft speed is not higher than the predetermined watercraft speed threshold in the extender mode. Further, the main controller 101 controls the engine speed at the engine speed level higher than the target power generation engine speed level when the watercraft speed is higher than the predetermined watercraft speed threshold in the extender mode. With this arrangement, the engine speed is kept at the predetermined target power generation engine speed level when the watercraft speed is not higher than the predetermined watercraft speed threshold. Therefore, the battery 145 can be reliably charged. When the watercraft speed is higher than the predetermined watercraft speed threshold, the battery charging amount for the charging of the battery 145 can be increased by increasing the engine speed to higher than the target power generation engine speed level. The watercraft speed threshold is preferably set properly based on the water sound and/or the wind sound of the hull 2 and the engine sound. Thus, the watercraft 1 can be sailed in the extender mode when the engine speed falls within an engine speed range in which the engine sound is not excessively loud.

In this example embodiment, the target power generation engine speed level can be variably set by operating the input device 10 of the gauge 9. In this example embodiment, specifically, the input device 10 is an example of the target power generation engine speed level setter operable by the user to variably set the target power generation engine speed level. The user can increase or reduce the target power generation engine speed level as required and, therefore, can make the setting so as to place more importance, for example, on the quietness of the watercraft 1 or on the charging of the battery 145. For the setting of the target power generation engine speed level, a target engine speed level may be directly set, or may be set indirectly by selecting a power generation level.

In this example embodiment, the engine outboard motor OM as the engine propulsion device includes the engine 30, the propeller 32, and the shift mechanism 33 to interrupt a power transmission path between the engine 30 and the propeller 32. The engine ECU 40 of the engine outboard motor OM is programmed to allow the shift mechanism 33 to shift in at an engine speed of not higher than the predetermined target shift-in engine speed level.

In this case, the shift-in is allowed at any time as required without adjusting the engine speed when the watercraft speed is the predetermined watercraft speed threshold if the target power generation engine speed level is not higher than the target shift-in engine speed level. Therefore, it is preferable to variably set the target power generation engine speed level to not higher than the target shift-in engine speed level by operating the input device 10 of the gauge 9.

In this example embodiment, the main controller 101 performs the deceleration control to reduce the engine speed to not higher than the target shift-in engine speed level when the shift-in request is issued in the extender mode. That is, when the target power generation engine speed level is higher than the target shift-in engine speed level, the deceleration control is performed to reduce the engine speed to not higher than the target shift-in engine speed level. This makes it possible to allow the shift mechanism 33 to shift in at an engine speed of not higher than the target shift-in engine speed level, thus suppressing a shock (shift shock) and sound which may otherwise occur due to the shift-in.

While example embodiments of the present invention have thus been described, the invention may be embodied in some other ways.

In the example embodiments described above, the single engine outboard motor OM is disposed at the middle portion of the stern 3, and the single electric outboard motor EM is disposed on the left side of the middle portion of the stern 3. The number and the layout of the engine outboard motor and the electric outboard motor are not limited to those described above. For example, another electric outboard motor may be additionally provided on the right side of the middle portion of the stern 3. Further, two engine outboard motors may be disposed on opposite sides of the middle portion of the stern 3 with the single electric outboard motor disposed therebetween. The electric outboard motor may be disposed on a portion of the hull 2 other than the stern 3.

Further, the engine propulsion device and the electric propulsion device are not limited to outboard motors. For example, the propulsion devices may be inboard motors, inboard/outboard motors, waterjet propulsion devices, or other types of propulsion devices. The engine propulsion device and the electric propulsion device may be of different types.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A watercraft propulsion system comprising:
an engine propulsion device including a power generator;
an electric propulsion device connected to a battery charged by the power generator; and
a controller including at least one operation mode including an extender mode in which the electric propulsion device generates a propulsive force and the power generator of the engine propulsion device is driven to charge the battery, the controller being configured or programmed to change an engine speed of the engine propulsion device according to a watercraft speed in the extender mode.

2. The watercraft propulsion system according to claim 1, wherein the controller is configured or programmed to keep the engine speed of the engine propulsion device at a predetermined target power generation engine speed level when the watercraft speed is not higher than a predetermined watercraft speed threshold in the extender mode, and to keep the engine speed of the engine propulsion device higher than the target power generation engine speed level when the watercraft speed is higher than the predetermined watercraft speed threshold in the extender mode.

3. The watercraft propulsion system according to claim 2, further comprising a target power generation engine speed level setter operable by a user to variably set the target power generation engine speed level.

4. The watercraft propulsion system according to claim 2, wherein
the engine propulsion device includes an engine, a propeller, and a shift mechanism to interrupt a power transmission path between the engine and the propeller;
the engine propulsion device is configured to allow the shift mechanism to shift in at an engine speed of not higher than a predetermined target shift-in engine speed level; and
the target power generation engine speed level is not higher than the target shift-in engine speed level.

5. The watercraft propulsion system according to claim 2, wherein
the engine propulsion device includes an engine, a propeller, and a shift mechanism to interrupt a power transmission path between the engine and the propeller;
the engine propulsion device is configured to allow the shift mechanism to shift in at an engine speed of not higher than a predetermined target shift-in engine speed level; and
the controller is configured or programmed to perform a deceleration control to reduce the engine speed of the engine propulsion device to not higher than the target shift-in engine speed level when a shift-in request is received in the extender mode.

6. The watercraft propulsion system according to claim 1, wherein the watercraft speed is a watercraft log speed.

7. The watercraft propulsion system according to claim 1, wherein the watercraft speed is a watercraft ground speed.

8. The watercraft propulsion system according to claim 1, wherein the engine propulsion device is an outboard motor.

9. A watercraft propulsion system comprising:
an electric propulsion device to be connected to a battery charged by a power generator driven by an engine; and
a controller configured or programmed to change a speed of the engine according to a watercraft speed.

10. The watercraft propulsion system according to claim 9, further comprising an outboard motor including the engine.

11. A watercraft comprising:
a hull; and
the watercraft propulsion system according to claim 1 mounted on the hull.

12. A watercraft comprising:
a hull; and
the watercraft propulsion system according to claim 9 mounted on the hull.
